(19) United States
(12) Patent Application Publication
(10) Pub. No.: US 2026/0262031 A1
(43) Pub. Date: Sep. 3, 2026

(54) COMMUNICATION METHOD, COMMUNICATION APPARATUS, TERMINAL, AND NETWORK DEVICE

(71) Applicant: SPREADTRUM COMMUNICATIONS (SHANGHAI) CO., LTD., Pudong New Area, Shanghai (CN)

(72) Inventor: Yun DENG, Pudong New Area, Shanghai (CN)

(73) Assignee: SPREADTRUM COMMUNICATIONS (SHANGHAI) CO., LTD., Pudong New Area, Shanghai (CN)

(21) Appl. No.: 19/154,576

(22) PCT Filed: Feb. 7, 2024
(86) PCT No.: PCT/CN2024/076539

§ 371 Date: Aug. 7, 2025

(30) Foreign Application Priority Data
Feb. 17, 2023 (CN) 202310135282.5

(51) Int. Cl. H04W 72/115; H04W 72/21

(52) U.S. Cl. CPC H04W 72/115; H04W 72/21

(57) ABSTRACT

A communication method, a communication apparatus, a terminal, and a network device are provided. The method includes: receiving a transmission configuration of at least one configured grant (CG), where the transmission configuration includes one or more transmission occasions within a single period; and transmitting indication information, where the indication information is used to indicate a target transmission occasion, and the target transmission occasion is an unused transmission occasion after a first time interval.

### CROSS-REFERENCE TO RELATED APPLICATIONS

This application is a National Stage of International Application No. PCT/CN2024/076539, filed on Feb. 7, 2024, which claims priority to Chinese Patent Application No. 202310135282.5, entitled “COMMUNICATION METHOD, COMMUNICATION APPARATUS, TERMINAL, AND NETWORK DEVICE”, filed with the China National Intellectual Property Administration on Feb. 17, 2023. The above two applications are hereby incorporated by reference in their entireties.

### TECHNICAL FIELD

The present disclosure relates to the field of communication technologies, and in particular, to a communication method, a communication apparatus, a terminal, and a network device.

### BACKGROUND

For a periodic service, a network device can configure a semi-static transmission resource for a terminal, so that efficient transmission of data can be realized almost without consuming physical layer control signaling. For uplink transmission, allocation of this semi-static transmission resource is referred to as configured grant (CG).

In the standardization of the third generation partnership project (3GPP), two types of CG have been discussed at present: Type 1 CG and Type 2 CG. Time-frequency parameters of uplink transmission resources are completely configured by radio resource control (RRC) signaling for Type 1 CG, while parameters of some transmission resources (such as period) are configured by RRC signaling for Type 2 CG, and then Type 2 CG is activated by downlink control information (DCI).

### SUMMARY

In a first aspect, an embodiment of the present disclosure provides a communication method, including: receiving a transmission configuration of at least one configured grant (CG), where the transmission configuration includes one or more transmission occasions within a single period; and transmitting indication information, where the indication information is used to indicate a target transmission occasion, and the target transmission occasion is an unused transmission occasion after a first time interval.

In a second aspect, an embodiment of the present disclosure provides a communication method, including: transmitting a transmission configuration of at least one configured grant (CG), where the transmission configuration includes one or more transmission occasions within a single period; and receiving indication information, where the indication information is used to indicate a target transmission occasion, and the target transmission occasion is an unused transmission occasion after a first time interval.

In a third aspect, an embodiment of the present disclosure provides a communication apparatus, including: a receiving module, configured to receive a transmission configuration of at least one configured grant (CG), where the transmission configuration includes one or more transmission occasions within a single period; and a transmitting module, configured to transmit indication information, where the indication information is used to indicate a target transmission occasion, and the target transmission occasion is an unused transmission occasion after a first time interval.

In a fourth aspect, an embodiment of the present disclosure provides a communication apparatus, including: a transmitting module, configured to transmit a transmission configuration of at least one configured grant (CG), where the transmission configuration includes one or more transmission occasions within a single period; and a receiving module, configured to receive indication information, where the indication information is used to indicate a target transmission occasion, and the target transmission occasion is an unused transmission occasion after a first time interval.

In a fifth aspect, an embodiment of the present disclosure provides a communication method, including: receiving deactivation indication information, where the deactivation indication information is used to indicate at least one transmission occasion that is deactivated within a single period for one or more configured grants (CGs).

In a sixth aspect, an embodiment of the present disclosure provides a communication method, including: transmitting deactivation indication information, where the deactivation indication information is used to indicate at least one transmission occasion that is deactivated within a single period for one or more configured grants (CGs).

In a seventh aspect, an embodiment of the present disclosure provides a communication apparatus, including: a receiving module, configured to receive deactivation indication information, where the deactivation indication information is used to indicate at least one transmission occasion that is deactivated within a single period for one or more configured grants (CGs).

In an eighth aspect, an embodiment of the present disclosure provides a communication apparatus, including: a transmitting module, configured to transmit deactivation indication information, where the deactivation indication information is used to indicate at least one transmission occasion that is deactivated within a single period for one or more configured grants (CGs).

In a ninth aspect, an embodiment of the present disclosure provides a computer-readable storage medium, on which a computer program is stored, and when the computer program is run by a processor, the above communication method provided by any one of the above aspects is executed.

In a tenth aspect, an embodiment of the present disclosure provides a terminal, including a memory and a processor, where the memory stores a computer program executable on the processor, and the processor executes steps of the communication method provided by the first aspect or the fifth aspect when running the computer program.

In an eleventh aspect, an embodiment of the present disclosure provides a network device, including a memory and a processor, where the memory stores a computer program executable on the processor, and the processor executes steps of the communication method provided by the second aspect or the sixth aspect when running the computer program.

In a twelfth aspect, an embodiment of the present disclosure further provides a chip (or communication apparatus) on which a computer program is stored, and when the computer program is executed by the chip, the communication method provided by any one of the above aspects is executed.

In a thirteenth aspect, an embodiment of the present disclosure further provides a chip module on which a computer program is stored, and when the computer program is executed by the chip module, the communication method provided by any one of the above aspects is executed.

In a fourteenth aspect, an embodiment of the present disclosure further provides a computer program product including a computer program that, when run on a computer, causes the computer to execute the communication method provided by any one of the above aspects.

In a fifth aspect, an embodiment of the present disclosure further provides a communication system including an apparatus for executing the method provided by the first aspect or the fifth aspect and an apparatus for executing the method provided by the second aspect or the sixth aspect.

### BRIEF DESCRIPTION OF DRAWINGS

FIG. 1 is a schematic diagram of signaling interaction of a communication method in an embodiment of the present disclosure.

FIG. 2 is a schematic diagram of a target transmission occasion in a scenario in an embodiment of the present disclosure.

FIG. 3 is a schematic diagram of a target transmission occasion in another scenario in an embodiment of the present disclosure.

FIG. 4 is a schematic diagram of signaling interaction of another communication method in an embodiment of the present disclosure.

FIG. 5 is a schematic structural diagram of a communication apparatus in an embodiment of the present disclosure.

FIG. 6 is a schematic structural diagram of another communication apparatus in an embodiment of the present disclosure.

FIG. 7 is a schematic structural diagram of yet another communication apparatus in an embodiment of the present disclosure.

FIG. 8 is a schematic structural diagram of still another communication apparatus in an embodiment of the present disclosure.

FIG. 9 is a schematic diagram of a hardware structure of a terminal in an embodiment of the present disclosure.

### DESCRIPTION OF EMBODIMENTS

It should be noted that the communication system applicable to embodiments of the present disclosure includes, but is not limited to, a 3th-generation (3G) system, a long term evolution (LTE) system, a 4th-generation (4G) system, a 5th-generation (5G) system and a new radio (NR) system, and a future evolution system or multiple communication fusion systems. Among them, the 5G system can be either a non-standalone (NSA) 5G system or a standalone (SA) 5G system. The solutions of the embodiments of the present disclosure can also be applied to various future new communication systems, for example, 6th-generation (6G) system and 7th-generation (7G) system, etc.

The terminal in the embodiments of the present disclosure can refer to various forms of user equipment (UE), access terminals, user units, user stations, mobile stations, mobile stations (MS), remote stations, remote terminals, mobile devices, user terminals, terminal equipment, wireless communication devices, user agents, or user apparatuses. The terminal can also be a cellular phone, a cordless phone, a session initiation protocol (SIP) phone, a wireless local loop (WLL) station, a personal digital assistant (PDA), a handheld device with wireless communication functions, a computing device, or other processing devices connected to a wireless modem, a vehicle-mounted device, a wearable device, a terminal in the future 5G network, or a terminal in the future-evolved public land mobile network (PLMN), etc., which are not limited in the embodiments of the present disclosure.

The network device in the embodiments of the present disclosure can also be referred to as an access network device. For example, it can be a base station (BS) (can also be called as a base station device). The network device is an apparatus deployed in a radio access network (RAN) to provide wireless communication functions. For example, in the 2nd-generation (2G) network, the apparatus that provides base station functions includes a base transceiver station (BTS). In the 3rd-generation (3G) network, the apparatus that provides base station functions includes a NodeB. In the 4th-generation (4G) network, the apparatus that provides base station functions includes an evolved NodeB (eNB). In wireless local area networks (WLANs), the apparatus that provides base station functions is an access point (AP). In NR, the apparatus that provides base station functions is a next-generation node base station (gNB), as well as a further evolved NodeB (ng-eNB). Communication between the gNB and the terminal device employs NR technology, and communication between the ng-eNB and the terminal device employs evolved universal terrestrial radio access (E-UTRA) technology. Both gNB and ng-eNB can be connected to the 5G core network. The network device in the embodiments of the present disclosure also includes devices for providing base station functions in future new communication systems.

In the solution in the related art, only one uplink transmission occasion is configured in one CG period. In order to meet the uplink service demand, 3GPP is currently considered to allow the network device to configure multiple transmission occasions in one CG period for the terminal to use.

In view of this, an embodiment of the present disclosure provides a communication method. In the solution of the embodiment of the present disclosure, a network device transmits a transmission configuration of at least one CG to a terminal, where the transmission configuration includes multiple transmission occasions within a single period, and the terminal can transmit indication information to the network device, where the indication information is used to indicate a target transmission occasion. The target transmission occasion is an unused transmission occasion after a first time interval, so that the network device can know the unused transmission occasion of the terminal after receiving the indication information, and further use the target transmission occasion to provide a service for other terminals, which is beneficial to avoiding resource waste. Since the terminal reports the unused transmission occasion after the first time interval, the solution in the embodiments of the present disclosure takes into account that it takes time for the serving cell to receive the indication information from the terminal, perform processing on the indication information, and reschedule the resources. Therefore, time is reserved for the network device to receive and process the indication information through the first time interval. Compared with the solution of reporting all the unused transmission occasions, the above solution can help to avoid a situation that the reported transmission occasions cannot be used by the network device and avoid power consumption caused by meaningless reporting.

To make the above-mentioned purposes, features and beneficial effects of the present disclosure more obvious and understandable, the specific embodiments of the present disclosure are described in detail below in combination with the accompanying drawings.

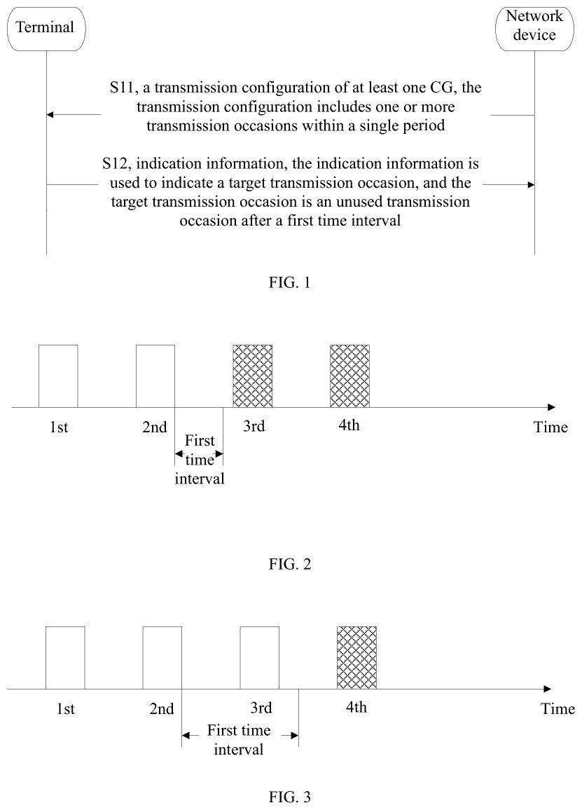

Referring to FIG. 1, FIG. 1 is a schematic diagram of signaling interaction of a communication method in an embodiment of the present disclosure. The communication method shown in FIG. 1 can include S11 to S12.
S11: a network device transmits a transmission configuration of at least one CG to a terminal, where the transmission configuration includes one or more transmission occasions within a single period.
S12: the terminal transmits indication information to the network device, where the indication information is used to indicate a target transmission occasion, and the target transmission occasion is an unused transmission occasion after a first time interval.

In a specific implementation, the terminal accesses a serving cell and establishes a radio resource control (RRC) connection. After an authentication is completed, one or more data radio bearers (DRBs) are established between the terminal and the network device. Then data transmission can be started.

For each DRB, the terminal can report characteristics of each service through UE assistance information, such as a period of data packet generation, a time offset of data packet generation, a data packet size and other parameters, so that the network device configures an appropriate transmission resource for the terminal.

In the embodiment of the present disclosure, the network device can configure one or more CGs for the terminal.

Specifically, the network device transmits the transmission configuration of the at least one CG to the terminal, where the transmission configuration of the at least one CG can be used for the transmission of the same service, and the transmission configuration of each CG can include a set of transmission resource parameters, where the transmission resource parameters can include: a period (or may also be referred to as a CG period), the number of transmission occasions within a single period, a time interval between two adjacent transmission occasions, and the like. In the embodiment of the present disclosure, the transmission configuration of CG can be a configuration for physical uplink shared channel (PUSCH) transmission, that is, the transmission configuration of CG can be a CG-PUSCH configuration. The network device can transmit the transmission configuration of CG to the terminal through RRC signaling, or RRC signaling and physical layer signaling.

In a specific implementation, when the network device configures one or more CGs, a logical channel corresponding to each CG can also be configured, and each CG can be only used for data transmission of a logical channel corresponding to this CG. As an example, the terminal has a service demand of an extended reality (XR), after the terminal transmits characteristic information of the XR service, the network device can configure one or more CGs for the terminal, and the configured CGs can only be used for the XR service.

Further, after receiving the transmission configuration of the at least one CG, the terminal can determine each transmission occasion within each period according to the transmission resource parameters, and use one or more transmission occasions to transmit data.

In the solution of this embodiment of the present disclosure, the terminal can report at least a part of unused transmission occasions to the network device. The unused transmission occasion can refer to a transmission occasion that the terminal does not need to use. That is, an unused transmission occasion can refer to a transmission occasion that the terminal does not need to use in the future. Specifically, the terminal reports the target transmission occasion to the network device, where the target transmission occasion is an unused transmission occasion after the first time interval. In a specific implementation, a starting time of the first time interval can be a time when the indication information is transmitted, and a length of the first time interval can be defined by a protocol, or can be configured by the network device. In other embodiments, the first time interval can also be referred to as a “first time window”.

In specific implementations, the starting time of the first time interval can be any of the followings:
(1) an end time of a slot in which the indication information is transmitted, for example, it can be an end time of the last symbol of the slot used for transmitting the indication information;
(2) a starting time of a next slot following the slot in which the indication information is transmitted, for example, it can be a starting time of a first symbol of the next slot following the slot used for transmitting the indication information;
(3) an end time of a symbol (the last symbol) where an uplink grant carrying the indication information is located. For example, assuming that the indication information is carried in the 2nd transmission occasion within CG period and the transmission occasion occupies the first 7 symbols of slot n, the starting time of the first time interval can be an end time of the 7th symbol;
(4) a starting time of a next symbol following the symbol (the last symbol) where the uplink grant carrying the indication information is located. For example, continuing the example in (3), the starting time of the first time interval can be a starting time of the 8th symbol of slot n;
(5) an end time of a symbol (the last symbol) in which the indication information is transmitted, in other words, it can be the end time of the symbol used for transmitting the indication information in the uplink grant carrying the indication information. Continuing the example in (3), the 3rd symbol and the 4th symbol in the first 7 symbols of slot n are used for transmitting the indication information, then the starting time of the first time interval can be an end time of the 4th symbol; and
(6) a starting time of a next symbol following the symbol (the last symbol) in which the indication information is transmitted, in other words, it can be the starting time of the next symbol following the symbol used for transmitting the indication information in the uplink grant carrying the indication information. Continuing the example in (5), the starting time of the first time interval can be a starting time of the 5th symbol of slot n.

Furthermore, according to the starting time of the first time interval and the length of the first time interval, the unused transmission occasions located after the first time interval can be determined. Specifically, for each unused transmission occasion, if the unused transmission occasion falls within the first time interval, the unused transmission occasion is not the target transmission occasion; otherwise, if the unused transmission occasion is located after the first time interval, the unused transmission occasion is the target transmission occasion. In a specific implementation, if part of an unused transmission occasion is located after the first time interval, that is, part of the unused transmission occasion is located within the first time interval, then the unused transmission occasion is not the target transmission occasion.

As mentioned above, the length of the first time interval can be configured by the network device.

Specifically, before S12, the network device can transmit threshold configuration information to the terminal, the threshold configuration information can be used to configure the first time interval. Specifically, the threshold configuration information can include the length of the first time interval. In a specific implementation, the threshold configuration information can be transmitted to the terminal together with the transmission configuration of CG in S11, but it is not limited to this.

More specifically, different serving cells can configure the same or different lengths of the first time interval for the terminal. For example, in carrier aggregation, different serving cells can configure the same or different lengths of the first time interval for the terminal. Specifically, in the scenario where different serving cells adopt different subcarrier spacings in carrier aggregation, the different serving cells can configure the same or different lengths of the first time interval. That is, serving cells operating on different subcarriers can configure the same or different lengths of the first time interval.

In a specific implementation, the network device can configure the length of the first time interval according to the processing capacity and uplink scheduling situation of the serving cell, etc.

Without limitation, in a scenario, the serving cell applies scheduling of subslot (less than one slot), and the serving cell can configure multiple UEs to monitor the physical downlink control channel (PDCCH) for many times within the same slot. For example, one slot has two sets of PDCCH configurations, which are distributed in the first 7 symbols and the last 7 symbols of the one slot, and there are 14 orthogonal frequency division multiplexing (OFDM) symbols in the one slot. In this scenario, the serving cell has relatively strong resource processing ability, can quickly process the indication information reported by the terminal, and can quickly perform resource rescheduling. Therefore, the serving cell can configure a relatively smaller interval threshold, that is, the length of the first time interval is relatively smaller. For example, the length of the first time interval can be smaller than a time interval between two adjacent transmission occasions.

Referring to FIG. 2, FIG. 2 is a schematic diagram of a target transmission occasion in an embodiment of the present disclosure. FIG. 2 takes the number of transmission occasions within a single period as 4, and the time interval between two adjacent transmission occasions as 1 slot (that is, for a subcarrier spacing of 15 kHz, the interval between two adjacent transmission occasions is 2 ms) as an example. FIG. 2 shows a scenario where the serving cell configures a relatively smaller interval threshold.

It is assumed that the terminal determines that the first (1st) transmission occasion and the second (2nd) transmission occasion are used transmission occasions, and the third (3rd) transmission occasion and the fourth (4th) transmission occasion are unused transmission occasions in the future.

As shown in FIG. 2, since the third transmission occasion and the fourth transmission occasion are both located after the first time interval, the third transmission occasion and the fourth transmission occasion are both target transmission occasions. Further, the terminal can transmit the indication information on the second transmission occasion.

In another scenario, the serving cell does not apply the scheduling of subslot, and all terminals in the serving cell monitor the PDCCH in units of slots. In this scenario, the resource processing ability of the serving cell is relatively weak, so the serving cell can configure a relatively larger interval threshold, that is, the length of the first time interval is relatively longer. For example, the length of the first time interval can be greater than the time interval between two adjacent transmission occasions.

Referring to FIG. 3, FIG. 3 is a schematic diagram of a target transmission occasion in an embodiment of the present disclosure. Different from FIG. 2, FIG. 3 shows a scenario where the serving cell configures a larger interval threshold.

As shown in FIG. 3, since the third transmission occasion falls within the first time interval and the fourth transmission occasion is located after the first time interval, the third transmission occasion is not the target transmission occasion, but the fourth transmission occasion is the target transmission occasion.

In another embodiment of the present disclosure, the target transmission occasion can be an unused transmission occasion after the first time interval within the current period. In other words, each unused transmission occasion within a period after the current period is not the target transmission occasion. The current period can refer to the CG period in which the time of transmitting the indication information is located. It should be noted that periods of different CGs can be different, and therefore, current periods can be different for different CGs.

In yet another embodiment of the present disclosure, the target transmission occasion can be an unused transmission occasion after the first time interval and before a second time interval. The second time interval can be defined by a protocol or configured by the network device. For example, the threshold configuration information can also be used to configure the second time interval, and the threshold configuration information can also include a length of the second time interval. The length of the second time interval is greater than the length of the first time interval.

The second time interval can be referred to as a “second time window”. In addition, a starting time of the second time interval can be the same as the starting time of the first time interval, and the content of the starting time of the second time interval can refer to the relevant description of the starting time of the first time interval above, which is not repeated here.

The above solution takes into account that the terminal usually can only judge the unused transmission occasions within a relatively short period of time, and cannot predict whether to use the transmission occasions after a longer period of time. Therefore, by limiting the target transmission occasion within the current period or before the second time interval, it helps to avoid false reporting and reduce signaling overhead.

Continue to refer to FIG. 1, further, in S12, the terminal transmits the indication information to the network device to report the target transmission occasion.

In a specific implementation, the indication information can be transmitted as a part of uplink control information (UCI). In other words, the indication information can belong to UCI. In practical application, the UCI to which the indication information belongs can also include channel state information, etc. reported by the terminal.

In a non-limiting example, the UCI can be the UCI in the configured grant, that is, the UCI can be transmitted on a transmission occasion corresponding to the configured grant. Specifically, the UCI can be transmitted on the last used transmission occasion within the current period. In other words, the terminal can transmit the indication information on the last used transmission occasion within the current period. Taking FIG. 2 and FIG. 3 as examples, the terminal can transmit the indication information on the second transmission occasion.

In an embodiment of the present disclosure, the indication information can include first indication information, and the first indication information is used to indicate a target transmission occasion of a current CG.

Specifically, the terminal can only report the target transmission occasion of the current CG. The current CG can refer to the CG currently used by the terminal. In this case, it may be not necessary for the terminal to report an identification of the current CG, that is, it may be that the indication information does not include the identification of the current CG. In this case, after receiving the indication information, the network device can default that the CG to which the target transmission occasion belongs is the configured grant corresponding to the transmission occasion used by the terminal. The transmission occasion used by the terminal refers to the transmission occasion used by the terminal to transmit the indication information.

In another embodiment of the present disclosure, the indication information can include second indication information, and the second indication information is used to indicate a target transmission occasion of one or more CGs in the at least one CG.

In a specific implementation, the terminal can, based on the transmission occasion of the current CG, report the target transmission occasion of the current CG and the target transmission occasions of one or more CGs except the current CG in the CG configured by the network in S11. That is, in this case, the second indication information can be transmitted through the current CG resource.

In another implementation, before S12, the network device can indicate to the terminal one or more CGs that need to report the target transmission occasion. The CGs that need to report the target transmission occasion can be at least a part of the CG configured by the terminal in S11. Further, in response to the indication of the network device, the terminal can transmit the second indication information. In a specific implementation, the terminal can use CG resources to transmit the second indication information, or the terminal can also use uplink transmission resources other than the configured grant resources to transmit the second indication information.

Furthermore, considering that a first transmission occasion of each CG is usually used by the terminal, there may be only one transmission occasion within a period configured by a certain CG. Therefore, in the solution of the embodiment of the present disclosure, if the number of transmission occasions of any CG is only one, the terminal can ignore the target transmission occasion of the CG at this time. “Ignoring the target transmission occasion of the CG” can be that the target transmission occasion of the CG is not reported or that the target transmission occasion of the CG is uncertain. Adopting such a solution helps to further avoid false reporting.

As mentioned above, the indication information can be transmitted to the network device as part of UCI.

Specifically, the UCI can include first indication information corresponding to the at least one CG, and the first indication information can correspond to CGs that need to report the target transmission occasion one by one. Each piece of the first indication information is used to carry a target transmission occasion of a CG corresponding to this first indication information.

In an example, an order or position of the first indication information corresponding to each CG in the UCI is determined according to an identification of this CG. For example, the smaller the identification of the CG, the more forward the order or position of the first indication information corresponding to this CG in the UCI.

In another example, the order or position of the first indication information corresponding to each CG in the UCI can be configured by the network device.

Specifically, before S12, the network device can transmit information element (IE) configuration information to the terminal, and the information element configuration information can be used to configure the order or position of the first indication information corresponding to the at least one CG in the UCI.

For example, the information element configuration information can be used to configure one or more CGs that need to report the target transmission occasions, and orders or positions of the first indication information corresponding to the one or more CGs that need to report the target transmission occasions.

Furthermore, each piece of the first indication information can include at least one indication bit, and the indication bit is used to indicate whether the transmission occasion is a target transmission occasion.

In a specific implementation, the number of indication bits contained in each piece of the first indication information is equal to the number of transmission occasions of a CG corresponding to the first indication information within a single period. Each indication bit in the present disclosure is an element, which is not repeated below.

Assuming that the number of transmission occasions of a certain CG within a single period is N, and N is a positive integer greater than 1, the first indication information corresponding to the CG can include N indication bits, and the i-th indication bit among the N indication bits is used to indicate whether the i-th transmission occasion of the CG corresponding to the first indication information within the current period is the target transmission occasion. For example, if the i-th indication bit is 1, then the i-th transmission occasion is the target transmission occasion, and if the i-th indication bit is 0, then the i-th transmission occasion is not the target transmission occasion, where i is a positive integer, 1≤i≤N.

In another specific implementation, the number of indication bits contained in each piece of the first indication information is equal to the number of transmission occasions of a CG corresponding to the first indication information within a single period minus 1.

Assuming that the number of transmission occasions of a certain CG within a single period is N, and N is a positive integer greater than 1, the first indication information corresponding to the CG can include N−1 indication bits, and the i-th indication bit among the N−1 indication bits is used to indicate whether the (i+1)-th transmission occasion of the CG corresponding to the first indication information within the current period is the target transmission occasion. For example, if the i-th indication bit is 1, then the (i+1)-th transmission occasion is the target transmission occasion, and if the i-th indication bit is 0, then the (i+1)-th transmission occasion is not the target transmission occasion, where i is a positive integer, 1<i<N−1.

The above solution takes into account that the first transmission occasion of each CG is usually used by the terminal, and the first transmission occasion is usually not the target transmission occasion, which is beneficial to reducing the required number of bits and lowing signaling overhead.

In another specific implementation, the above information element configuration information can also be used to configure the number of bits contained in the first indication information corresponding to each CG.

Specifically, the network device can configure the number of bits of respective first indication information for different CGs based on the usage of transmission occasions corresponding to different CGs.

More specifically, for a certain CG, the number of transmission occasions of this CG within a single period is N, and the network device can configure the number of bits contained in first indication information corresponding to this CG to be Q, where 1≤Q≤N. The q-th bit among Q bits is used to indicate whether the (N−Q+q)-th transmission occasion among N transmission occasions is the target transmission occasion, where 1≤q≤Q.

For example, the terminal is configured with two CGs (CG1 and CG2), where CG1 has 4 transmission occasions within a single period, and CG2 has 5 transmission occasions within a single period. The network device can configure the number of bits required for each CG to report the first indication information. For instance, both CG1 and CG2 require 3 bits to report the first indication information. For CG1, the 1st bit among the 3 bits indicates whether the 2nd transmission occasion within the CG1 period is the target transmission occasion, the 2nd bit indicates whether the 3rd transmission occasion within the CG1 period is the target transmission occasion, and the 3rd bit indicates whether the 4th transmission occasion within the CG1 period is the target transmission occasion. For CG2, the first indication information with 3 bits also corresponds to whether the last three transmission occasions within the CG2 period will be used.

In the above solution, the network device configures the specific number of bits for the first indication information corresponding to the CG, so that the terminal can better organize the first indication information for different CGs, enhance the flexibility of reporting and also help to reduce unnecessary signaling overhead.

It should be noted that when reporting target transmission occasions of multiple CGs, the indication information also needs to include information for indicating the CG.

As an example, the indication information can include an identification field of CG, which can be used to indicate a CG to which the target transmission occasion belongs, where the identification field of CG can be selected from the identification of CG. That is, the identification field is a part of the identification of CG configured by the network device.

For example, in S11, the network device configures 2 CGs, where an identification of CG1 is 0001 and an identification of CG2 is 0010. In S12, the terminal reports target transmission occasions of CG1 and CG2. To reduce signaling overhead, the last two bits of the identification of the CG can be selected as an identification field to indicate this CG. That is, an identification field of CG1 in the indication information is 01, and an identification field of CG2 is 10.

From the above, according to the solution of the embodiment of the present disclosure, the terminal reports the target transmission occasion to the network device, so that the network device can accurately know the transmission occasion that can be rescheduled, and avoid resource waste and invalid reporting.

Referring to FIG. 4, FIG. 4 is a flowchart of another communication method in an embodiment of the present disclosure. The method shown in FIG. 4 can be performed by a terminal. Specifically, the method shown in FIG. 4 can include S41.

S41: a terminal receives deactivation indication information, where the deactivation indication information is used to indicate at least one transmission occasion that is deactivated within a single period for one or more configured grants (CGs).

Specifically, before executing S41, S11 shown in FIG. 1 can be performed first, that is, the network device transmits the transmission configuration of the at least one CG to the terminal. For specific content, refer to the related description of FIG. 1 above.

Furthermore, after executing S11 and before executing S41, the terminal can report the unused transmission occasion of each CG to the network device.

Within a period after executing S11, if the terminal consistently has the unused transmission occasion for a certain CG, the network device can deactivate the transmission occasion in that CG that are consistently unused. Taking FIG. 3 as an example, assuming that the terminal never needs to use the last two transmission occasions, the network device can deactivate the last two transmission occasions of the CG within a single period, or it can deactivate one of the last two transmission occasions.

Continuing to refer to FIG. 4, as an example, if a certain transmission occasion of a certain CG within a single period is not used in K periods, the network device can perform deactivation of this transmission occasion. In other words, when the number of times that the terminal indicates that the j-th transmission occasion of any CG is an unused transmission occasion within a single period reaches a preset threshold, the network device can deactivate the j-th transmission occasion of the CG, where j is a positive integer.

As another example, if a certain transmission occasion of a certain CG within a single period is the above-mentioned target transmission occasion in K periods, the network device can perform deactivation on this transmission occasion. In other words, when the number of times that the terminal indicates that the j-th transmission occasion of any CG is the target transmission occasion within a single period reaches a preset threshold, the network device can deactivate the j-th transmission occasion of the CG.

In an embodiment of the present disclosure, the deactivation indication information can be used not only to indicate the deactivated CG, but also to indicate the deactivated transmission occasion in the deactivated CG.

It should be noted that the term “deactivation” in the embodiment of the present disclosure can refer to release.

It should also be noted that in the embodiment of the present disclosure, the deactivated CG can be partially deactivated, that is, the deactivated CG can reserve at least one available transmission occasion within single period, in other words, the deactivated CG can have at least one transmission occasion within a single period that is not deactivated. Alternatively, the deactivated CG can be completely deactivated, that is, the deactivated CG can have no available transmission occasions within a single period, and all transmission occasions of the deactivated CG within the single period are deactivated.

In other embodiments, the deactivation indication information can be used to indicate the transmission occasion reserved in the deactivated CG, and the terminal can determine the deactivated transmission occasion according to the transmission configuration of the CG and the deactivation indication information.

Further, after receiving the deactivation indication information, the terminal can determine the deactivated CG and the deactivated transmission occasion in the deactivated CG according to the deactivation indication information, and further, the terminal cannot use the deactivated transmission occasion.

In a non-limiting example, the deactivation indication information can be used to indicate at least one transmission occasion that is deactivated within a single period for one or more CGs during a third time interval. The third time interval can also be referred to as a “third time window”, a starting time of the third time interval can be a time when the terminal receives the deactivation indication information, and the deactivation indication information can include a length of the third time interval. Alternatively, the length of the third time interval can be predefined by protocol. The length of the third time interval can be an integer multiple of the period of the deactivated CG. For example, if the deactivation indication information is used to indicate partial transmission occasions of the deactivated CG1 within the third time interval, the length of the third time interval may be 5 times the period length of CG1.

Further, the deactivated transmission occasion indicated by the deactivation indication information is deactivated in the third time interval and resumed after the third time interval, that is, the terminal can still use the deactivated transmission occasion indicated by the deactivation indication information after the third time interval.

In a first specific implementation, the deactivation indication information can be carried in a first downlink control information (DCI). A single DCI can be used to deactivate partial transmission occasions of one CG.

Specifically, for a certain deactivated CG, the network device can scramble by a configured scheduled-radio network temporary identifier (CS-RNTI) corresponding to the CG to obtain a first DCI, and the first DCI can be used to deactivate partial transmission occasions of the CG.

Specifically, the first DCI can include a first hybrid automatic repeat request (HARQ) process number, and the terminal can determine the deactivated CG indicated by the first DCI and the deactivated transmission occasion within a single period for the CG according to the first HARQ process number in the first DCI.

More specifically, before S41, the network device can transmit first configuration information to the terminal, where the first configuration information includes multiple first HARQ process numbers and an indication object of each first HARQ process number, and the indication object includes a single deactivated CG and a transmission occasion that is deactivated within a single period for the CG. The first configuration information can be transmitted after S11.

For example, if the CG configured by the network device includes CG1 and CG2, and a length of the first HARQ process number is 4 bits, the multiple first HARQ process numbers included in the first configuration information can be 0001, 0010, 0011, 0100, 0101, 0110, 0111, 1000. An indication object of the first HARQ process number 0001 can be all transmission occasions of CG1 within a single period, an indication object of the first HARQ process number 0010 can be the last transmission occasion of CG1 within a single period, an indication object of the first HARQ process number 0011 can be the last two transmission occasions of CG1 within a single period, an indication object of the first HARQ process number 0100 can be the last three transmission occasions of CG1 within a single period, an indication object of the first HARQ process number 0101 can be all transmission occasions of CG2 within a single period, an indication object of the first HARQ process number 0110 can be the last transmission occasion of CG2 within a single period, an indication object of the first HARQ process number 0111 can be the last two transmission occasions of CG2 within a single period, and an indication object of the first HARQ process number 1000 can be the last three transmission occasions of CG2 within a single period.

In practical application, each first HARQ process number and its respective indication object can be set differently according to the actual situation, and this embodiment is not limited to this.

Using the above solution, if the network device needs to deactivate certain transmission occasions of a certain CG, the network device can transmit the first DCI scrambled by the CS-RNTI corresponding to this CG, and carry the corresponding first HARQ process number to indicate the deactivated transmission occasions.

In a second specific implementation, the deactivation indication information can be carried in the first DCI. A single first DCI can be used to deactivate partial transmission occasions of 1 CG. As described in the first specific implementation, the first DCI can be obtained by scrambling the CS-RNTI corresponding to the deactivated CG.

Different from the solution of the first specific implementation mentioned above, the first DCI can include a second HARQ process number and second indication information. Unlike the first HARQ process number, the second HARQ process number can be used to indicate the deactivated CG, for example, the second HARQ process number can be an identification for the deactivated CG. That is, the second process number is not used to indicate the deactivated transmission occasion.

Further, the second indication information can be used to indicate the deactivated transmission occasion within a single period. That is, the second indication information may be CG-independent. After receiving the deactivation indication information, the terminal can first determine the deactivated CG according to the second HARQ process number, and then determine the deactivated transmission occasion in the deactivated CG according to the second indication information.

In a specific implementation, the second indication information can be a newly added element compared with the DCI in the related art. Alternatively, the second indication information can be an unused element in the DCI in the related art, such as a time domain resource assignment element.

In an example, the second indication information can include M bits, and a j-th bit among the M bits is used to indicate whether the j-th transmission occasion within a single period is deactivated, where M is a positive integer greater than 1, and 1≤j≤M. The value of M can be the number of transmission occasions for CG indicated by the second HARQ process number within a single period.

For example, the length of the second indication information is 4 bits, which can be used to indicate the situation of deactivation of 4 transmission occasions in a CG period. If the second indication information is 1100, it means that the first two transmission occasions are reserved and the last two transmission occasions are deactivated. If the second indication information is 1110, it means that the last transmission occasion is deactivated.

In another example, before executing S41, the network device can transmit second configuration information to the terminal, where the second configuration information can include multiple values of the second indication information and a deactivated transmission occasion corresponding to each value. After receiving the first DCI, the terminal can determine the deactivated transmission occasion according to the value of the second indication information and the second configuration information in the first DCI.

In a third specific implementation, the deactivation indication information can be carried in a second DCI, the second DCI can include identifications of one or more deactivated CGs and a deactivated transmission occasion in each deactivated CG. For example, the second DCI can include identifications of multiple deactivated CGs and the second indication information corresponding to each CG.

It should be noted that, unlike the first DCI, the second DCI can be a DCI dedicated to the transmission occasion of the deactivated CG. In addition, a single first DCI can only be used to deactivate partial transmission occasions of one CG, while a single second DCI can be used to deactivate partial transmission occasions of multiple CGs.

From the above, through the solution provided by the embodiments of the present disclosure, the network device can perform deactivation with the transmission occasion as granularity, thus enhancing the flexibility of CG transmission occasion, which is conducive to optimizing uplink scheduling and avoiding the situation that uplink transmission resources are wasted.

In other embodiments of the present disclosure, if a first transmission occasion of a current CG is not deactivated, the terminal can use the first transmission occasion to retransmit data transmitted by a transmission occasion used by the current CG. The first transmission occasion can be any unused transmission occasion of the current CG. More specifically, a used transmission occasion can be randomly selected and the data transmitted by the transmission occasion can be retransmitted on the first transmission occasion. Alternatively, the data transmitted by the first transmission occasion of the current CG in a period can be retransmitted on the first transmission occasion.

For more information about the method shown in FIG. 4, refer to the related description of FIG. 1, and will not be repeated here.

It can be understood that in specific implementation, the above method can be realized in the form of a software program, the software program runs in a processor integrated in a chip or chip module. Alternatively, the method can be realized using hardware or a combination of hardware and software, for example, using a dedicated chip or chip module, or using a combination of a dedicated chip or chip module and a software program.

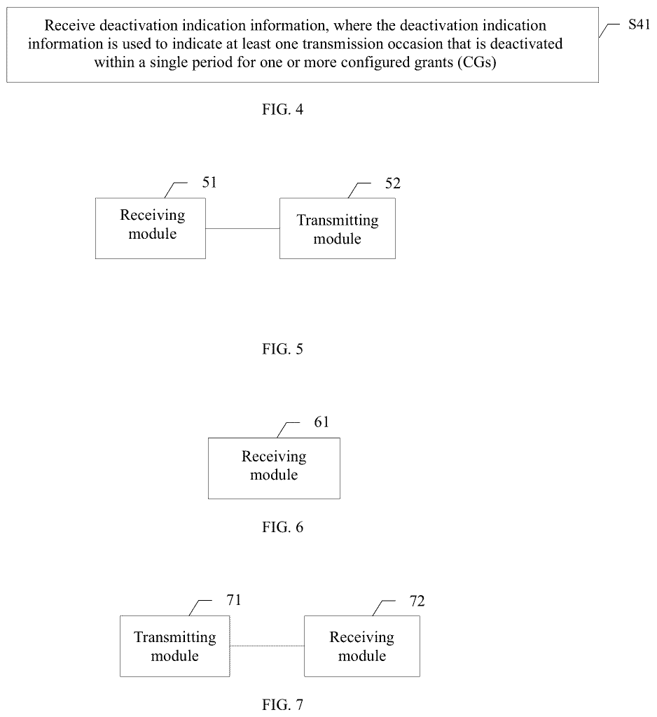

Referring to FIG. 5, FIG. 5 is a schematic structural diagram of a communication apparatus in an embodiment of the present disclosure. The communication apparatus shown in FIG. 5 can be deployed on the above-mentioned terminal, and the apparatus shown in FIG. 5 can include:
a receiving module 51, configured to receive a transmission configuration of at least one configured grant (CG), where the transmission configuration includes one or more transmission occasions within a single period;
a transmitting module 52, configured to transmit indication information, where the indication information is used to indicate a target transmission occasion, and the target transmission occasion is an unused transmission occasion after a first time interval.

Referring to FIG. 6, FIG. 6 is a schematic structural diagram of another communication apparatus in an embodiment of the present disclosure. The communication apparatus shown in FIG. 6 can be deployed on the above-mentioned terminal, and the apparatus shown in FIG. 6 can include:
a receiving module 61, configured to receive deactivation indication information, where the deactivation indication information is used to indicate at least one transmission occasion that is deactivated within a single period for one or more configured grants (CGs).

In specific implementations, the communication apparatuses shown in FIG. 5 and FIG. 6 can correspond to chips with communication function in the terminal; or correspond to a chip or chip module with communication function included in the terminal, or corresponding to the terminal.

Referring to FIG. 7, FIG. 7 is a schematic structural diagram of yet another communication apparatus in an embodiment of the present disclosure. The communication apparatus shown in FIG. 7 can be deployed on the above-mentioned network device, and the apparatus shown in FIG. 7 can include:
a transmitting module 71, configured to transmit a transmission configuration of at least one configured grant (CG), where the transmission configuration includes one or more transmission occasions within a single period;
a receiving module 72, configured to receive indication information, where the indication information is used to indicate a target transmission occasion, and the target transmission occasion is an unused transmission occasion after a first time interval.

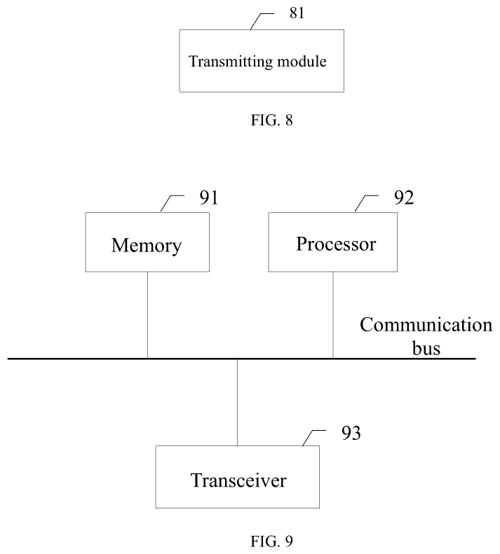

Referring to FIG. 8, FIG. 8 is a schematic structural diagram of still another communication apparatus in an embodiment of the present disclosure. The communication apparatus shown in FIG. 8 can be deployed on the network device, and the apparatus shown in FIG. 8 can include:
a transmitting module 81, configured to transmit deactivation indication information, where the deactivation indication information is used to indicate at least one transmission occasion that is deactivated within a single period for one or more configured grants (CGs).

In specific implementations, the communication apparatuses shown in FIG. 7 and FIG. 8 can correspond to chips with communication function in the network device; or correspond to a chip or chip module with communication function included in the network device, or corresponding to the network device.

For more content such as a working principle, a working method, and a beneficial effect of the communication apparatus in the embodiments of the present disclosure, reference may be made to the above related description of the communication method, and details are not described herein again.

An embodiment of the present disclosure also provides a computer-readable storage medium, on which a computer program is stored, and when the computer program is run by a processor, the above communication method is executed. The storage medium can include a ROM, a RAM, a magnetic disk, an optical disk, or the like. The storage medium can further include a non-volatile memory or a non-transitory memory.

An embodiment of the present disclosure also provides a terminal, including a memory and a processor, where the memory stores a computer program executable on the processor, and the processor executes steps of the above communication method when running the computer program. The terminal includes, but is not limited to, a terminal device such as a mobile phone, a computer, a tablet computer, and the like. The terminal can be a mobile phone, a computer, a tablet computer, a vehicle-mounted terminal, a wearable device, and the like, but is not limited thereto.

Referring to FIG. 9, FIG. 9 is a schematic diagram of a hardware structure of a terminal in an embodiment of the present disclosure. The terminal shown in FIG. 9 includes a memory 91, a processor 92 and a transceiver 93, the processor 92 is coupled to the memory 91 and the transceiver 93, and the memory 91 can be located in the terminal, or can be located outside the terminal. The memory 91, the processor 92, and the transceiver 93 can be connected by a communication bus. The transceiver 93 is configured to communicate with another device or a communication network.

In an implementation, the transceiver 93 can be a transmitter. The memory 91 stores a computer program executable on the processor 92, and when the processor 92 runs the computer program, the transceiver 93 performs the steps in the communication method provided in the above embodiments.

An embodiment of the present disclosure further provides a network device, including a memory and a processor, where the memory stores a computer program executable on the processor, and the processor executes steps of the above communication method when running the computer program.

For a hardware structure of the network device, reference may be made to the related description of FIG. 9, and details are not described herein again.

It should be understood that, in the embodiments of the present disclosure, the processor can be a central processing unit (CPU), and the processor can be another general-purpose processor, a digital signal processor (DSP), an application-specific integrated circuit (ASIC), a field programmable gate array (FPGA), another programmable logic device, a discrete gate or transistor logic device, a discrete hardware component, or the like. The general-purpose processor can be a microprocessor, or the processor can be any other processor or the like.

It should be further understood that the memory in this embodiment of the present disclosure can be a volatile memory or a non-volatile memory, or can include both a volatile memory and a non-volatile memory. The non-volatile memory can be a read-only memory (ROM), a programmable read-only memory (PROM), an erasable programmable read-only memory (EPROM), an electrically erasable programmable read-only memory (EEPROM), or a flash memory. The volatile memory can be a random access memory (RAM), which is used as an external cache. By way of example and not limitation, many forms of random access memory (RAM) are available, such as static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synchlink dynamic random access memory (SLDRAM), and direct rambus random access memory (DR RAM).

The above embodiments can be implemented in whole or in part through software, hardware, firmware or any other combination. When implemented using software, the above embodiments can be implemented in whole or in part in the form of computer program product. The computer program product includes one or more computer instructions or computer programs. When loading or executing the computer instructions or computer programs on a computer, the processes or functions described in the embodiments of the present disclosure are generated in whole or in part. The computer can be a general-purpose computer, a special-purpose computer, a computer network, or other programmable devices. The computer program can be stored in a computer-readable storage medium or transmitted from one computer-readable storage medium to another computer-readable storage medium. For example, the computer program can be transmitted from one website site, computer, server or data center to another website site, computer, server or data center through wired or wireless means.

It should be understood that in the various embodiments of the present disclosure, the size of the sequence numbers of the aforementioned processes does not imply the order of execution. The execution order of each process should be determined based on its function and internal logic, and should not constitute any limitation on the implementation process of the embodiments of the present disclosure.

In the several embodiments provided in the present disclosure, it should be understood that the disclosed methods, apparatuses and systems can be realized in other ways. For example, the apparatus embodiments described above are merely illustrative. For example, the division of the unit is merely a logical functional division, and there can be another division method in actual implementation. For example, multiple units or components can be combined or integrated into another system, or some features can be omitted or not executed. Another point is that the coupling or direct coupling or communication connection between each other shown or discussed can be indirect coupling or communication connection through some interfaces, apparatuses or units, which can be in electrical, mechanical or other forms.

The units described as separate components may or may not be physically separate. The components displayed as units may or may not be physical units, that is, they may be located in one place or distributed across multiple network units. Some or all of these units can be selected according to actual needs to achieve the objectives of solution of this embodiment.

In addition, each functional unit in each embodiment of the present disclosure can be integrated into one processing unit, or each unit can be physically included separately, or two or more units can be integrated into one unit. The aforementioned integrated units can be implemented either in the form of hardware or in the form of a combination of hardware and software functional units. For example, for apparatus(s) or product(s) applied to or integrated into a chip, all modules/units included therein may be implemented through hardware such as circuit(s), or at least part of modules/units may be implemented through software program(s) running on processor(s) integrated within the chip, while the remaining modules/units (if any) may be implemented through hardware such as circuit(s). For apparatus(s) or product(s) applied to or integrated within a chip module, all modules/units included therein may be implemented through hardware such as circuits, where different modules/units may reside on either the same component (e.g., a chip, circuit module, etc.) or different components of the chip module; alternatively, at least part of the modules/units may be implemented via software program(s) running on processor(s) integrated within the chip module, while any remaining modules/units (if any) may be implemented through hardware such as circuit(s). For apparatus(s) or product(s) applied to or integrated within a terminal, all modules/units included therein may be implemented through hardware such as circuits, where different modules/units may reside within either the same component (e.g., a chip, circuit module, etc.) or different components of the terminal; alternatively, at least part of the modules/units may be implemented via software program(s) running on processor(s) integrated within the terminal, while any remaining modules/units (if any) may be implemented through hardware such as circuit(s).

The aforementioned integrated units implemented in the form of software functional units can be stored in a computer-readable storage medium. The aforementioned software functional unit is stored in a storage medium, including several instructions for enabling a computer device (which can be a personal computer, server, or network device, etc.) to perform part of the steps of the methods described in various embodiment of the present disclosure. The aforementioned storage media include: a disk, a mobile hard disk, a read-only memory (ROM), a random access memory (RAM), a magnetic disk or an optical disk and other media that can store program codes.

It should be understood that the term “and/or” in this text is only a kind of relationship describing associated objects, indicating that there can be three possible relationships. For example, A and/or B can represent that there are three relationships: A exists alone, both A and B exist simultaneously, and B exists alone. Additionally, the character “/” in this text indicates that the associated objects before and after it are in an “or” relationship.

The “multiple” appeared in the embodiments of the present disclosure refers to two or more.

The first and second descriptions appeared in the embodiments of the present disclosure are only for illustration and to distinguish the described objects, and there is no order and they do not represent any special limitation on the number of devices in the embodiments of the present disclosure and cannot constitute any restriction on the embodiments of the present disclosure.

One of the technical objectives of the present disclosure is to provide a communication method, a communication apparatus, a terminal, and a network device, which can help to avoid a problem that the network device can no longer reschedule an unused transmission occasion reported by the terminal.

In a first aspect, an embodiment of the present disclosure provides a communication method, including: receiving a transmission configuration of at least one configured grant (CG), where the transmission configuration includes one or more transmission occasions within a single period; and transmitting indication information, where the indication information is used to indicate a target transmission occasion, and the target transmission occasion is an unused transmission occasion after a first time interval.

In an implementation, the indication information includes first indication information, and the first indication information is used to indicate a target transmission occasion of a current CG.

In an implementation, the indication information includes second indication information, and the second indication information is used to indicate a target transmission occasion of one or more CGs in the at least one CG.

In an implementation, the method further includes: if the number of transmission occasions of any CG is only one, ignoring the target transmission occasion of the CG.

In an implementation, the indication information belongs to uplink control information (UCI), the UCI includes first indication information corresponding to the at least one CG, each piece of the first indication information is used to carry a target transmission occasion of a CG corresponding to this first indication information.

In an implementation, an order or position of the first indication information corresponding to the at least one CG in the UCI is determined according to an identification of the at least one CG; or, before the transmitting the indication information, the method further includes: receiving information element configuration information, where the information element configuration information is used to configure the order or position of the first indication information corresponding to the at least one CG in the UCI.

In an implementation, the information element configuration information is also used to configure the number of bits contained in first indication information corresponding to each CG.

In an implementation, the first indication information includes N−1 indication bits, and a i-th indication bit among the N−1 indication bits is used to indicate whether a (i+1)-th transmission occasion of the CG corresponding to the first indication information in a current period is the target transmission occasion; where N is the number of the transmission occasions of the CG corresponding to the first indication information within the single period, 1≤i≤N−1, and i is a positive integer.

In an implementation, the indication information includes an identification field of a CG, the identification field of the CG is used to indicate a CG to which the target transmission occasion belongs, and where the identification field of the CG corresponds to an identification of the CG.

In an implementation, a starting time of the first time interval is any of followings: an end time of a slot in which the indication information is transmitted, or a starting time of a next slot following the slot in which the indication information is transmitted; an end time of a symbol where an uplink grant carrying the indication information is located, or a starting time of a next symbol following the symbol where the uplink grant carrying the indication information is located; an end time of a symbol in which the indication information is transmitted, or a starting time of a next symbol following the symbol in which the indication information is transmitted.

In an implementation, the target transmission occasion is an unused transmission occasion after the first time interval within a current period; or, the target transmission occasion is an unused transmission occasion after the first time interval and before a second time interval; where a length of the first time interval is smaller than a length of the second time interval.

In an implementation, before the transmitting the indication information, the method further includes: receiving threshold configuration information, where the threshold configuration information is used to configure the first time interval.

In an implementation, lengths of first time intervals corresponding to different serving cells are the same or different.

In a second aspect, an embodiment of the present disclosure provides a communication method, including: transmitting a transmission configuration of at least one configured grant (CG), where the transmission configuration includes one or more transmission occasions within a single period; and receiving indication information, where the indication information is used to indicate a target transmission occasion, and the target transmission occasion is an unused transmission occasion after a first time interval.

In an implementation, the indication information includes first indication information, and the first indication information is used to indicate a target transmission occasion of a current CG.

In an implementation, the indication information includes second indication information, and the second indication information is used to indicate a target transmission occasion of one or more CGs in the at least one CG.

In an implementation, the method further includes: if the number of transmission occasions of any CG is only one, ignoring the target transmission occasion of the CG.

In an implementation, the indication information belongs to uplink control information (UCI), the UCI includes first indication information corresponding to the at least one CG, each piece of the first indication information is used to carry a target transmission occasion of a CG corresponding to this first indication information.

In an implementation, an order or position of the first indication information corresponding to the at least one CG in the UCI is determined according to an identification of the at least one CG; or, before the receiving the indication information, the method further includes: transmitting information element configuration information, where the information element configuration information is used to configure the order or position of the first indication information corresponding to the at least one CG in the UCI.

In an implementation, the information element configuration information is also used to configure the number of bits contained in first indication information corresponding to each CG.

In an implementation, each piece of the first indication information includes N−1 indication bits, and a i-th indication bit among the N−1 indication bits is used to indicate whether a (i+1)-th transmission occasion of the CG corresponding to the first indication information in a current period is the target transmission occasion; where N is the number of the transmission occasions within the single period, 1≤i≤N−1, and i is a positive integer.

In an implementation, the indication information includes an identification field of a CG, the identification field of the CG is used to indicate a CG to which the target transmission occasion belongs, and where the identification field of the CG corresponds to an identification of the CG.

In an implementation, a starting time of the first time interval is any of followings: an end time of a slot in which the indication information is transmitted, or a starting time of a next slot following the slot in which the indication information is transmitted; an end time of a symbol where an uplink grant carrying the indication information is located, or a starting time of a next symbol following the symbol where the uplink grant carrying the indication information is located; an end time of a symbol in which the indication information is transmitted, or a starting time of a next symbol following the symbol in which the indication information is transmitted.

In an implementation, the target transmission occasion is an unused transmission occasion after the first time interval within a current period; or, the target transmission occasion is an unused transmission occasion after the first time interval and before a second time interval; where a length of the first time interval is smaller than a length of the second time interval.

In an implementation, before the receiving the indication information, the method further includes: transmitting threshold configuration information, where the threshold configuration information is used to configure the first time interval.

In an implementation, lengths of first time intervals corresponding to different serving cells are the same or different.

In a third aspect, an embodiment of the present disclosure provides a communication apparatus, including: a receiving module, configured to receive a transmission configuration of at least one configured grant (CG), where the transmission configuration includes one or more transmission occasions within a single period; and a transmitting module, configured to transmit indication information, where the indication information is used to indicate a target transmission occasion, and the target transmission occasion is an unused transmission occasion after a first time interval.

In a fourth aspect, an embodiment of the present disclosure provides a communication apparatus, including: a transmitting module, configured to transmit a transmission configuration of at least one configured grant (CG), where the transmission configuration includes one or more transmission occasions within a single period; and a receiving module, configured to receive indication information, where the indication information is used to indicate a target transmission occasion, and the target transmission occasion is an unused transmission occasion after a first time interval.

In a fifth aspect, an embodiment of the present disclosure provides a communication method, including: receiving deactivation indication information, where the deactivation indication information is used to indicate at least one transmission occasion that is deactivated within a single period for one or more configured grants (CGs).

In an implementation, the deactivation indication information is carried in a first downlink control information (DCI), the first DCI includes a first hybrid automatic repeat request (HARQ) process number, before the receiving the deactivation indication information, the method further includes: receiving first configuration information, where the first configuration information includes multiple first HARQ process numbers and an indication object of each first HARQ process number, and the indication object includes a deactivated CG and a transmission occasion that is deactivated within a single period for the deactivated CG.

In an implementation, the deactivation indication information is carried in a first DCI, the first DCI includes a second HARQ process number and second indication information, the second HARQ process number is used to indicate the deactivated CG, the second indication information is used to indicate the deactivated transmission occasion within a single period.

In an implementation, the second indication information includes M bits, and a j-th bit among the M bits is used to indicate whether the j-th transmission occasion within a single period is deactivated, where M is a positive integer greater than 1, and 1≤j≤M.

In an implementation, before the receiving the deactivation indication information, the method further includes: receiving second configuration information, where the second configuration information includes multiple values of the second indication information and a deactivated transmission occasion corresponding to each value.

In an implementation, the deactivation indication information is carried in a second DCI, the second DCI includes identifications of one or more deactivated CGs and a deactivated transmission occasion in each deactivated CG.

In an implementation, the transmission occasion indicated by the deactivation indication information is an unused transmission occasion in K periods, and K is a positive integer.

In an implementation, the method further includes: if a first transmission occasion of a current CG is not deactivated, using the first transmission occasion to retransmit data transmitted by a transmission occasion used by the current CG.

In an implementation, the deactivation indication information is used to indicate at least one transmission occasion that is deactivated within a single period for one or more CGs during a third time interval.

In a sixth aspect, an embodiment of the present disclosure provides a communication method, including: transmitting deactivation indication information, where the deactivation indication information is used to indicate at least one transmission occasion that is deactivated within a single period for one or more configured grants (CGs).

In an implementation, the deactivation indication information is carried in a first downlink control information (DCI), the first DCI includes a first hybrid automatic repeat request (HARQ) process number, before the transmitting the deactivation indication information, the method further includes: transmitting first configuration information, where the first configuration information includes multiple first HARQ process numbers and an indication object of each first HARQ process number, and the indication object includes a deactivated CG and a transmission occasion that is deactivated within a single period for the deactivated CG.

In an implementation, the deactivation indication information is carried in a first DCI, the first DCI includes a second HARQ process number and second indication information, the second HARQ process number is used to indicate the deactivated CG, the second indication information is used to indicate the deactivated transmission occasion within a single period.

In an implementation, the second indication information includes M bits, and a j-th bit among the M bits is used to indicate whether the j-th transmission occasion within a single period is deactivated, where M is a positive integer greater than 1, and 1≤j≤M.

In an implementation, before the transmitting the deactivation indication information, the method further includes: transmitting second configuration information, where the second configuration information includes multiple values of the second indication information and a deactivated transmission occasion corresponding to each value.

In an implementation, the deactivation indication information is carried in a second DCI, the second DCI includes identifications of one or more deactivated CGs and a deactivated transmission occasion in each deactivated CG.

In an implementation, the transmission occasion indicated by the deactivation indication information is an unused transmission occasion in K periods, and K is a positive integer.

In an implementation, if a first transmission occasion of a current CG is not deactivated, the first transmission occasion is used to retransmit data transmitted by a transmission occasion used by the current CG.

In an implementation, the deactivation indication information is used to indicate at least one transmission occasion that is deactivated within a single period for one or more CGs during a third time interval.

In a seventh aspect, an embodiment of the present disclosure provides a communication apparatus, including: a receiving module, configured to receive deactivation indication information, where the deactivation indication information is used to indicate at least one transmission occasion that is deactivated within a single period for one or more configured grants (CGs).

In an eighth aspect, an embodiment of the present disclosure provides a communication apparatus, including: a transmitting module, configured to transmit deactivation indication information, where the deactivation indication information is used to indicate at least one transmission occasion that is deactivated within a single period for one or more configured grants (CGs).

In a ninth aspect, an embodiment of the present disclosure provides a computer-readable storage medium, on which a computer program is stored, and when the computer program is run by a processor, the above communication method provided by any one of the above aspects is executed.

In a tenth aspect, an embodiment of the present disclosure provides a terminal, including a memory and a processor, where the memory stores a computer program executable on the processor, and the processor executes steps of the communication method provided by the first aspect or the fifth aspect when running the computer program.

In an eleventh aspect, an embodiment of the present disclosure provides a network device, including a memory and a processor, where the memory stores a computer program executable on the processor, and the processor executes steps of the communication method provided by the second aspect or the sixth aspect when running the computer program.

In a twelfth aspect, an embodiment of the present disclosure further provides a chip (or communication apparatus) on which a computer program is stored, and when the computer program is executed by the chip, the communication method provided by any one of the above aspects is executed.

In a thirteenth aspect, an embodiment of the present disclosure further provides a chip module on which a computer program is stored, and when the computer program is executed by the chip module, the communication method provided by any one of the above aspects is executed.

In a fourteenth aspect, an embodiment of the present disclosure further provides a computer program product including a computer program that, when run on a computer, causes the computer to execute the communication method provided by any one of the above aspects.

In a fifth aspect, an embodiment of the present disclosure further provides a communication system including an apparatus for executing the method provided by the first aspect or the fifth aspect and an apparatus for executing the method provided by the second aspect or the sixth aspect.

Compared with the related art, the technical solutions of the embodiments of the present disclosure have the following beneficial effects.

In the solution of the embodiments of the present disclosure, the network device transmits the transmission configuration of the at least one CG to the terminal, where the transmission configuration includes one or more transmission occasions within a single period, and the terminal can transmit the indication information to the network device, where the indication information is used to indicate the target transmission occasion. The target transmission occasion is the unused transmission occasion after the first time interval, so that the network device can know the unused transmission occasion of the terminal after receiving the indication information, and further use the target transmission occasion to provide a service for other terminals, which is beneficial to avoiding resource waste. Since the terminal reports the unused transmission occasion after the first time interval, the first time interval reserved time for the network device to receive the indication information, process the indication information and reschedule the resources. Compared with the solution of reporting all the unused transmission occasions, the above solution can help to avoid a situation that the reported transmission occasions cannot be used by the network device and avoid power consumption caused by meaningless reporting.

Furthermore, in the solution of the embodiments of the present disclosure, the first indication information includes N−1 indication bits, the i-th indication bit among the N−1 indication bits is used to indicate whether the (i+1)-th transmission occasion of the CG corresponding to the first indication information in the current period is the target transmission occasion, where N is the number of the transmission occasions within the single period. Considering that the first transmission occasion of the CG is always used by the terminal, the first indication information includes N−1 indication bits, which is beneficial to reduce signaling overhead.

Furthermore, in the solution of the embodiments of the present disclosure, in order to indicate the CG to which the reported target transmission occasion belongs, an identification field is selected from the identification of the CG to identify the CG. Compared with the solution of directly using the CG identification to indicate the CG, the above solution is beneficial to reducing signaling overhead.

Furthermore, in the solution of the embodiments of the present disclosure, the target transmission occasion is the unused transmission occasion after the first time interval and before the second time interval; or the target transmission occasion is the unused transmission occasion after the first time interval within the current period. Considering that the terminal usually can only judge the unused transmission occasions within a relatively short period of time, and cannot predict whether to use the transmission occasions after a longer period of time. Therefore, in the above solution, by limiting the target transmission occasion within the current period or before the second time interval, it helps to avoid false reporting and reduce signaling overhead.

Furthermore, in the solution of the embodiments of the present disclosure, configuring the length of the first time interval by the network device can make the first time interval conform to the resource processing capacity of the network device, make the adopted first time interval more reasonable, and help to ensure that the target transmission occasion reported by the terminal is a resource that can be scheduled by the network device.

Although the present disclosure is disclosed as above, the present disclosure is not limited thereto. Any person skilled in the art may make various changes and modifications without departing from the spirit and scope of the present disclosure. Therefore, the protection scope of the present disclosure shall be based on the scope defined by the claims.

1. A communication method, comprising:
receiving a transmission configuration of at least one configured grant (CG), wherein the transmission configuration comprises one or more transmission occasions within a single period; and
transmitting indication information, wherein the indication information is used to indicate a target transmission occasion, and the target transmission occasion is an unused transmission occasion after a first time interval.

2. The communication method according to claim 1, wherein the indication information comprises first indication information, and the first indication information is used to indicate a target transmission occasion of a current CG; or
wherein the indication information comprises second indication information, and the second indication information is used to indicate a target transmission occasion of one or more CGs in the at least one CG.

3. (canceled)

4. (canceled)

5. The communication method according to claim 1, wherein the indication information belongs to uplink control information (UCI), the UCI comprises first indication information corresponding to the at least one CG, the first indication information comprises at least one indication bit, and the indication bit is used to indicate whether a transmission occasion is the target transmission occasion.

6. The communication method according to claim 5, wherein an order or position of the first indication information corresponding to the at least one CG in the UCI is determined according to an identification of the at least one CG;
or, before the transmitting the indication information, the method further comprises:
receiving information element configuration information, wherein the information element configuration information is used to configure the order or position of the first indication information corresponding to the at least one CG in the UCI.

7. The communication method according to claim 1, wherein before the transmitting the indication information, the method further comprises:
receiving information element configuration information, wherein the information element configuration information is used to configure the number of bits contained in first indication information corresponding to the at least one CG.

8. The communication method according to claim 7, wherein the indication information sequentially indicates whether a transmission occasion is the target transmission occasion according to a time sequence, and the number of the transmission occasions is the number of bits.

9. The communication method according to claim 5, wherein the first indication information comprises N−1 indication bits, and a i-th indication bit among the N−1 indication bits is used to indicate whether a (i+1)-th transmission occasion of the CG corresponding to the first indication information in a current period is the target transmission occasion; wherein N is the number of the transmission occasions of the CG corresponding to the first indication information within the single period, 1≤≤N−1, and i is a positive integer.

10. (canceled)

11. The communication method according to claim 1, wherein a starting time of the first time interval is any of followings:
an end time of a slot in which the indication information is transmitted, or a starting time of a next slot following the slot in which the indication information is transmitted;
an end time of a symbol where an uplink grant carrying the indication information is located, or a starting time of a next symbol following the symbol where the uplink grant carrying the indication information is located;
an end time of a symbol in which the indication information is transmitted, or a starting time of a next symbol following the symbol in which the indication information is transmitted.

12. (canceled)

13. The communication method according to claim 1, wherein before the transmitting the indication information, the method further comprises:
receiving threshold configuration information, wherein the threshold configuration information is used to configure the first time interval:
wherein lengths of first time intervals corresponding to different serving cells are the same or different.

14. (canceled)

15. A communication method, comprising:
transmitting a transmission configuration of at least one configured grant (CG), wherein the transmission configuration comprises one or more transmission occasions within a single period; and
receiving indication information, wherein the indication information is used to indicate a target transmission occasion, and the target transmission occasion is an unused transmission occasion after a first time interval.

16. The communication method according to claim 15, wherein the indication information comprises first indication information, and the first indication information is used to indicate a target transmission occasion of a current CG; or
wherein the indication information comprises second indication information, and the second indication information is used to indicate a target transmission occasion of one or more CGs in the at least one CG.

17. (canceled)

18. (canceled)

19. The communication method according to claim 15, wherein the indication information belongs to uplink control information (UCI), the UCI comprises first indication information corresponding to the at least one CG, the first indication information comprises at least one indication bit, and the indication bit is used to indicate whether a transmission occasion is the target transmission occasion.

20. The communication method according to claim 19, wherein an order or position of the first indication information corresponding to the at least one CG in the UCI is determined according to an identification of the at least one CG;
or, before the receiving the indication information, the method further comprises:
transmitting information element configuration information, wherein the information element configuration information is used to configure the order or position of the first indication information corresponding to the at least one CG in the UCI.

21. The communication method according to claim 15, wherein before the receiving the indication information, the method further comprises:
transmitting information element configuration information, wherein the information element configuration information is used to configure the number of bits contained in first indication information corresponding to the at least one CG.

22. The communication method according to claim 21, wherein the indication information sequentially indicates whether a transmission occasion is the target transmission occasion according to a time sequence, and the number of the transmission occasions is the number of bits.

23. The communication method according to claim 19, wherein the first indication information comprises N−1 indication bits, and a i-th indication bit among the N−1 indication bits is used to indicate whether a (i+1)-th transmission occasion of the CG corresponding to the first indication information in a current period is the target transmission occasion; wherein N is the number of the transmission occasions of the CG corresponding to the first indication information within the single period, 1≤i≤N−1, and i is a positive integer.

24. (canceled)

25. The communication method according to claim 15, wherein a starting time of the first time interval is any of followings:
an end time of a slot in which the indication information is transmitted, or a starting time of a next slot following the slot in which the indication information is transmitted;
an end time of a symbol where an uplink grant carrying the indication information is located, or a starting time of a next symbol following the symbol where the uplink grant carrying the indication information is located;
an end time of a symbol in which the indication information is transmitted, or a starting time of a next symbol following the symbol in which the indication information is transmitted.

26. (canceled)

27. The communication method according to claim 15, wherein before the receiving the indication information, the method further comprises:
transmitting threshold configuration information, wherein the threshold configuration information is used to configure the first time interval;
wherein lengths of first time intervals corresponding to different serving cells are the same or different.

28-31. (canceled)

32. A terminal, comprising a memory and a processor, the memory stores thereon a computer program executable on the processor, wherein the processor, when running the computer program, is configured to:
receive a transmission configuration of at least one configured grant (CG), wherein the transmission configuration comprises one or more transmission occasions within a single period; and
transmit indication information, wherein the indication information is used to indicate a target transmission occasion, and the target transmission occasion is an unused transmission occasion after a first time interval.

33. A network device, comprising a memory and a processor, the memory stores thereon a computer program executable on the processor, wherein when the processor runs the computer program, steps of the communication method according to claim 15 are executed.
